(19) United States
(12) Patent Application Publication
(10) Pub. No.: US 2026/0032751 A1
(43) Pub. Date: Jan. 29, 2026

(54) Always Connected Drone Systems

(71) Applicant: Skydio, Inc., San Mateo, CA (US)

(72) Inventors: Sathish Damodaran, San Mateo, CA (US); Eyal Hochdorf, Palo Alto, CA (US)

(21) Appl. No.: 19/281,209

(22) Filed: Jul. 25, 2025

Related U.S. Application Data
(60) Provisional application No. 63/675,651, filed on Jul. 25, 2024.

(51) Int. Cl. H04W 76/19; H04B 7/185; H04W 12/041; H04W 12/0471; H04W 12/06

(52) U.S. Cl. CPC H04W 76/19; H04B 7/18506; H04W 12/041; H04W 12/0471; H04W 12/06

(57) ABSTRACT

A communication system is disclosed for maintaining persistent and secure wireless communication between a drone and a controller using an always connected mode. The drone operates as an 802.11 access point (AP), while the controller operates as a station (STA). During initial connection, the system performs a standard 802.11 association and key exchange, and stores the resulting association context, including the association response and encryption keys, to persistent memory. Upon detecting a disconnection or reboot, the system restores the saved context directly into the wireless driver to reinitialize MAC state and resume encrypted communication without repeating full association. The system includes modifications to wpa_supplicant, hostapd, and wireless drivers to support direct injection of association context and to temporarily disable replay protection. A dynamic switching mechanism selects between standard association and always connected mode based on runtime conditions such as link quality, proximity, or session validity.

### CROSS-REFERENCE TO RELATED APPLICATION(S)

This application claims the benefit of U.S. Provisional Patent Application No. 63/675,651, filed Jul. 25, 2024, the entire disclosure of which is hereby incorporated by reference.

### TECHNICAL FIELD

This disclosure relates to unmanned aerial vehicles (UAVs), and more specifically, to UAVs with persistent wireless connectivity with control stations.

### BACKGROUND

The advent of drones or unmanned aerial vehicles (UAVs) has revolutionized various sectors, including telecommunications and computer networks. Drones are increasingly being used for applications such as package delivery, surveillance, and disaster response, among others that require real-time, persistent communication between the UAV and a ground-based controller. Many commercial and industrial drone systems rely on IEEE 802.11 (Wi-Fi) protocols for wireless communication due to their high throughput and low latency characteristics. In a typical configuration, the UAV operates as an access point (AP), while the controller operates as a station (STA). Communication between the devices is established through the standard 802.11 Media Access Control (MAC) Layer Management Entity (MLME) procedures, which include scanning, authentication, association, and a 4-way handshake for cryptographic key exchange using WPA2-PSK or similar mechanisms.

The current process of discovery and association follows the standard association procedures as specified in any of the 802.11 protocol documents, with the AP advertising beacons, the STA scanning for known SSIDs with probe requests, and then selecting the AP to connect with, authenticating and associating with the AP, followed by the 4-way handshake where the keys for securing the communication frames are derived and used in communication.

In certain UAV applications, the 802.11 wireless link is optimized for extended range by utilizing Orthogonal Frequency-Division Multiple Access (OFDMA) resource unit (RU) blocks, adjusting acknowledgment (ACK) timeouts, and allocating dedicated time slots for uplink and downlink traffic. However, when the drone and controller are separated by significant distance, especially under normal Enhanced Distributed Channel Access (EDCA) mode, the link budget may be insufficient for reliable communication. In such cases, the devices may mistakenly determine that the connection has been lost and attempt to initiate a standard 802.11 reconnection sequence. These reconnection attempts often fail at extended ranges, effectively requiring the drone to return to closer proximity before reestablishing a connection using conventional procedures.

While the standard connection sequence is effective under stable and short-range conditions, it presents significant challenges in the dynamic and constrained environments in which UAVs often operate. First, the connection establishment process is susceptible to disruption due to distance, interference, or temporary power loss. If a UAV or controller reboots or moves out of signal range, the entire 802.11 connection sequence must be reinitiated, including beacon scanning and key exchange. This leads to undesirable delays, increased risk of mission failure, and the inability to recover communication in long-range or autonomous scenarios. These limitations are particularly detrimental in use cases such as autonomous navigation, search and rescue, infrastructure inspection, or any application where uninterrupted command and telemetry links are critical. These and other drawbacks exist.

### SUMMARY

In some aspects, the techniques described herein relate to a communication system for a drone, including: a wireless communication module configured to establish a wireless link between a drone and a controller by executing a standard 802.11 connection process including association, authentication and key exchange; a persistent memory in at least one of the drone and controller configured to store an association context including an association response and an encryption key derived during the standard 802.11 connection process; and a protocol control module configured to in response to a reconnection event, reestablish the wireless link using the association context without executing the standard 802.11 connection process.

In some aspects, the techniques described herein relate to a method for maintaining persistent wireless connectivity between a drone and a controller, the method including: establishing a wireless link between a drone and a controller by executing a standard connection process of an 802.11 protocol; storing an association context including an association response and encryption keys derived during the standard connection process; and reestablishing the wireless link during reconnection using the association context without executing the standard connection process.

In some aspects, the techniques described herein relate to an autonomous unmanned aerial vehicle (UAV) including: one or more sensors configured to capture perception inputs of a physical environment; a propulsion system configured to maneuver the UAV through the physical environment; and a communication system including a protocol control module configured to: detect a disconnection of a wireless link with a controller, retrieve, from a persistent memory of the UAV, an association context having an association response and encryption keys, wherein the association context was derived during a standard connection process of an 802.11 protocol used to initially establish the wireless link with the controller, and reestablish the wireless link using the association context without executing the standard connection process.

Various other aspects, features, and advantages of the disclosed embodiments will be apparent through the detailed description and the drawings attached hereto. It is also to be understood that both the foregoing general description and the following detailed description are examples, and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification “a portion,” refers to a part of, or the entirety of (i.e., the entire portion), a given item (e.g., data) unless the context clearly dictates otherwise.

### BRIEF DESCRIPTION OF THE DRAWINGS

FIG. 1 illustrates an example configuration of a top side of an unmanned aerial vehicle (UAV), consistent with various embodiments.

FIG. 2 illustrates an example configuration of a bottom side of the UAV, consistent with various embodiments.

FIG. 3 illustrates an example UAV architecture for a UAV configured with improved resilience against electronic warfare (EW), consistent with various embodiments.

FIGS. 4A and 4B illustrate a communication system architecture for always connected mode in drones, consistent with various embodiments.

FIG. 5 is a flow diagram of a method for establishing a wireless connection between a drone and a controller using a standard connection mode, consistent with various embodiments.

FIG. 6 is a flow diagram of a method for reestablishing a wireless connection between a drone and a controller using an always connected mode, consistent with various embodiments.

FIG. 7 is a flow diagram of a method for maintaining a wireless connection between a drone and a controller using a standard connection mode or always connected mode, consistent with various embodiments.

Embodiments will now be described in detail with reference to the drawings, which are provided as illustrative examples so as to enable those skilled in the art to practice the embodiments. Notably, the figures and examples below are not meant to limit the scope to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the embodiments will be described, and detailed descriptions of other portions of such known components will be omitted so as not to obscure the description of the embodiments. In the present specification, an embodiment showing a singular component should not be considered limiting; rather, the scope is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the scope encompasses present and future known equivalents to the components referred to herein by way of illustration.

### DETAILED DESCRIPTION

Disclosed are embodiments for maintaining persistent, secure wireless communication between a drone and a controller across various operating conditions, including power cycles and long-range disconnections. A drone communication system implements an “always connected mode,” in which the drone and controller re-establish a lost wireless communication link using a previously stored connection state, referred to as the “association context.” The association context includes, among other elements, an association response and encryption keys (e.g., pairwise transient key (PTK) and group temporal key (GTK)) derived during the initial standard (or full) 802.11 connection process that establishes a wireless link (e.g., for the first time) between the drone and the controller. The always connected bypasses authentication, association, and key negotiation of the standard 802.11 connection process by using the stored association context to re-establish the wireless link.

The controller saves the association context to a persistent memory after a successful association via the standard 802.11 connection process. Similarly, the drone stores per-station context, including media access control (MAC) address, key material, association ID (AID) identifying the controller, and key slot assignments for the keys as the association context in a persistent memory. In response to a reconnection event, including reboot of a device or disconnection of the wireless link due to other reasons, either device can use the stored association context to restore the wireless link without repeating the standard 802.11 connection process.

To enable always connected mode, key components of the 802.11 protocol stack are modified. For example, the controller's wpa_supplicant and the drone's hostapd are enhanced to save and reload association context. Vendor-specific Netlink commands are used to inject this association context into the wireless drivers (e.g., QCA drivers), which are further modified to accept pre-stored MLME state and directly program the associated encryption keys. These drivers initialize the MLME state and program encryption keys directly into hardware without waiting for beacons or frame exchanges. In some implementations, care can be taken to work with relatively large packet number (PN) jumps and wraparounds or a receiver falling back or forward in PN expectations. Additionally, Aggregated MAC Protocol Data Unit (AMPDU) and Block ACK (BA) sessions are re-established implicitly by the firmware, eliminating the need to store and restore aggregation state.

The drone communication system intelligently switches between always connected mode and standard connection mode (e.g., full 802.11 connection process) based on factors such as beacon availability, link quality, and proximity. If the association context is unavailable or if the signal strength is strong, the system may default to the standard connection mode. Otherwise, the system may use the always connected mode for reconnection using the saved association context. This dual-mode design ensures compatibility and resilience, enabling autonomous UAVs to maintain reliable communication during long-range operations, autonomous flights, unexpected reboots, or signal fades without manual intervention.

The embodiments address limitations of traditional 802.11-based UAV communication systems, which rely on standard 802.11 connection process requiring full reassociation and reauthentication after any disruption in the wireless link. The “always connected mode” overcomes these limitations by enabling seamless reconnection without repeating the standard 802.11 connection process.

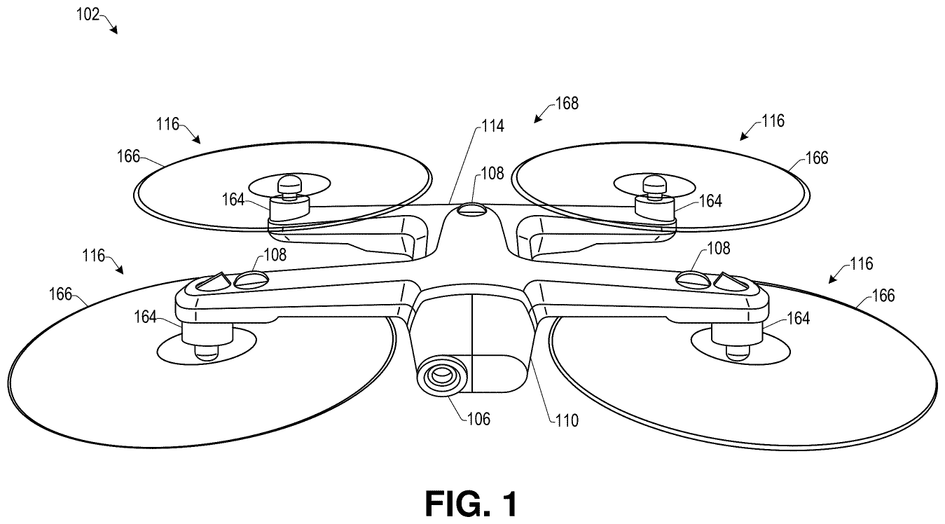

FIG. 1 illustrates an example configuration of a top side of an UAV, consistent with various embodiments. In this example, the UAV 102 includes a propulsion system 116 including four motors 164 and propellers 166 that is configured to maneuver the UAV through a physical environment. In this example, the UAV 102 is illustrated as a quadcopter drone, but implementations herein are not limited to such.

The UAV 102 includes a plurality of the second cameras 108 mounted on the body 114 of the UAV 102 and that may be used as navigation cameras in some cases. The UAV 102 further includes the aimable first camera 106 that may include a higher-resolution image sensor than the image sensors of the wider-angle cameras 108. In some cases, the first camera 106 includes a fixed focal length lens. In other cases, the first camera 106 may include a mechanically controllable, optically zoomable lens. The first camera 106 is mounted on the gimbal 110 that enables aiming of the first camera 106 in approximately a 180-degree hemispherical area to support steady, low-blur image capture and object tracking. For example, the first camera 106 may be used for capturing high resolution images of target objects, providing object tracking video, or various other operations.

In this example, three second cameras 108 are spaced out around the top side 168 of the UAV 102 and covered by respective fisheye lenses to provide a wide field of view and to support stereoscopic computer vision. The wider-angle cameras 108 on the top side 168 of the UAV 102, as well as those on the bottom side discussed below, may be precisely calibrated with respect to each other following installation on the body 114 of the UAV 102. As a result of the calibration, for each pixel in each of the images captured by the respective wider-angle cameras, the precise corresponding three-dimensional (3D) orientation with respect to a virtual sphere surrounding the UAV may be determined in advance. In some cases, six wider-angle cameras 108 are employed with a field of view (FOV) sufficiently wide (e.g., 180-degree FOV, 200-degree FOV, etc.) and are positioned on the body 114 of the UAV 102 for covering the entire spherical space around the UAV 102.

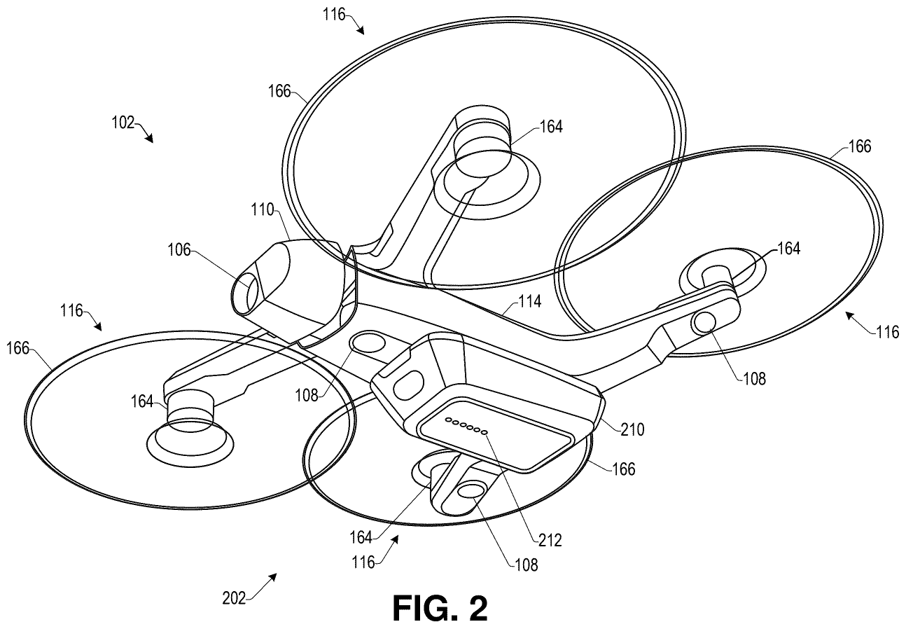

FIG. 2 illustrates an example configuration of a bottom side of the UAV, consistent with various embodiments. From this perspective three more second cameras 108 arranged on the bottom side 202 of the UAV 102 are illustrated. The second cameras 108 on the bottom side 202 may also be covered by respective fisheye lenses to provide a wide field of view and to support stereoscopic computer vision. This array of second cameras 108 (e.g., three on the top side and three on the bottom side of the UAV 102) may enable visual inertial odometry (VIO) for high resolution localization and obstacle detection and avoidance. For example, the array of second cameras 108 may be used to scan a surrounding area to obtain range data and provide image information that can be used to generate range maps indicating distances to objects detected in the FOVs of the second cameras 108, such as for use during autonomous navigation of the UAV 102 or for determining the distance of surfaces from the UAV 102.

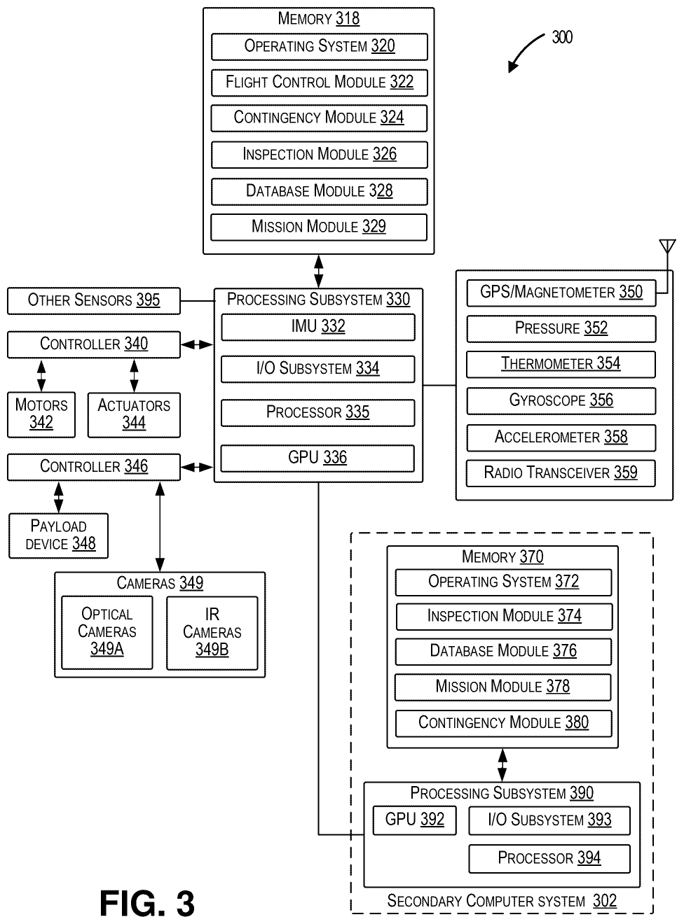

The UAV 102 may also include a battery pack 210 attached on the bottom side 202 of the UAV 102, with conducting contacts 212 to enable battery charging. The UAV 102 also includes an internal processing apparatus including one or more processors and a computer-readable medium (not shown in FIG. 2) as well as various other electronic and mechanical components. For example, the UAV 102 may include a hardware configuration as discussed with respect to FIG. 3 below.

FIG. 3 illustrates an example UAV architecture for a UAV configured with improved resilience against EW, consistent with various embodiments. In the examples herein, the UAV 102 may sometimes be referred to as a “drone” and may be implemented as any type of UAV capable of controlled flight without a human pilot onboard. For instance, the UAV 102 may be controlled autonomously by one or more onboard processors, such as processor 335, that execute one or more executable programs. Additionally, or alternatively, the UAV 102 may be controlled via a remote controller, such as through a remotely located controller operated by a human pilot and/or controlled by an executable program executing on or in cooperation with the controller.

A UAV can include a primary computer system 300 and a secondary computer system 302. The UAV primary computer system 300 can be a system of one or more computers, or software executing on a system of one or more computers, which is in communication with, or maintains, one or more databases. The UAV primary computer system 300 can include a processing subsystem 330 including one or more processors 335, graphics processing units 336, I/O subsystem 334, and an inertial measurement unit (IMU) 332. In addition, the UAV primary computer system 300 can include logic circuits, analog circuits, associated volatile and/or non-volatile memory, associated input/output data ports, power ports, etc., and include one or more software processes executing on one or more processors or computers. The UAV primary computer system 300 can include memory 318.

Memory 318 may include non-volatile memory, such as one or more magnetic disk storage devices, solid-state hard drives, or flash memory. Other volatile memory such as RAM, DRAM, SRAM may be used for temporary storage of data while the UAV is operational. Databases may store information describing UAV flight operations, flight plans, contingency events, geofence information, component information and other information.

The UAV primary computer system 300 may be coupled to one or more sensors, such as global navigation satellite system (GNSS) receivers 350 (e.g., GPS receivers), thermometer 354, gyroscopes 356, accelerometers 358, pressure sensors (static or differential) 352, and other sensors 395 that capture perception inputs of a physical environment. The other sensors 395 can include current sensors, voltage sensors, magnetometers, hydrometers, anemometers and motor sensors. The UAV may use IMU 332 in inertial navigation of the UAV. Sensors can be coupled to the UAV primary computer system 300, or to controller boards coupled to the UAV primary computer system 300. One or more communication buses, such as a controller area network (CAN) bus, or signal lines, may couple the various sensor and components.

Various sensors, devices, firmware and other systems may be interconnected to support multiple functions and operations of the UAV. For example, the UAV primary computer system 300 may use various sensors to determine the UAV's current geo-spatial position, attitude, altitude, velocity, direction, pitch, roll, yaw and/or airspeed and to pilot the UAV along a specified flight path and/or to a specified location and/or to control the UAV's attitude, velocity, altitude, and/or airspeed (optionally even when not navigating the UAV along a specific flight path or to a specific location).

The flight control module 322 handles flight control operations of the UAV. The module interacts with one or more controllers 340 that control operation of motors 342 and/or actuators 344. For example, the motors may be used for rotation of propellers, and the actuators may be used for flight surface control such as ailerons, rudders, flaps, landing gear and parachute deployment.

The contingency module 324 monitors and handles contingency events. For example, the contingency module 324 may detect that the UAV has crossed a boundary of a geofence, and then instruct the flight control module 322 to return to a predetermined landing location. The contingency module 324 may detect that the UAV has flown or is flying out of a visual line of sight (VLOS) from a ground operator, and instruct the flight control module 322 to perform a contingency action, e.g., to land at a landing location. Other contingency criteria may be the detection of a low battery or fuel state, a malfunction of an onboard sensor or motor, or a deviation from the flight plan. The foregoing is not meant to be limiting, as other contingency events may be detected. In some instances, if equipped on the UAV, a parachute may be deployed if the motors or actuators fail.

The mission module 329 processes the flight plan, waypoints, and other associated information with the flight plan as provided to the UAV in a flight package. The mission module 329 works in conjunction with the flight control module 322. For example, the mission module may send information concerning the flight plan to the flight control module 322, for example waypoints (e.g., latitude, longitude and altitude), flight velocity, so that the flight control module 322 can autopilot the UAV.

The UAV may have various devices connected to the UAV for performing a variety of tasks, such as data collection. For example, the UAV may carry one or more cameras 349. Cameras 349 can include one or more visible light cameras 349A, which can be, for example, a still image camera, a video camera, or a multispectral camera. The UAV may carry one or more infrared cameras 349B. Each infrared camera 349B can include a thermal sensor configured to capture one or more still or motion thermal images of an object, e.g., a solar panel. In addition, the UAV may carry a Lidar, radio transceiver, sonar, and traffic collision avoidance system (TCAS). Data collected by the devices may be stored on the device collecting the data, or the data may be stored on non-volatile memory 318 of the UAV primary computer system 300.

The UAV primary computer system 300 may be coupled to various radios, e.g., transceivers 359 for manual control of the UAV, and for wireless or wired data transmission to and from the UAV primary computer system 300, and optionally a UAV secondary computer system 302. The UAV may use one or more communications subsystems, such as a wireless communication or wired subsystem, to facilitate communication to and from the UAV. Wireless communication subsystems may include radio transceivers, infrared, optical ultrasonic and electromagnetic devices. Wired communication systems may include ports such as Ethernet ports, USB ports, serial ports, or other types of port to establish a wired connection to the UAV with other devices, such as a ground control station (GCS), flight planning system (FPS), or other devices, for example a mobile phone, tablet, personal computer, display monitor, other network-enabled devices. The UAV may use a lightweight tethered wire to a GCS for communication with the UAV. The tethered wire may be affixed to the UAV, for example via a magnetic coupler.

The UAV can generate flight data logs by reading various information from the UAV sensors and operating system 320 and storing the information in computer-readable media (e.g., non-volatile memory 318). The data logs may include a combination of various data, such as time, altitude, heading, ambient temperature, processor temperatures, pressure, battery level, fuel level, absolute or relative position, position coordinates (e.g., GPS coordinates), pitch, roll, yaw, ground speed, humidity level, velocity, acceleration, and contingency information. The foregoing is not meant to be limiting, and other data may be captured and stored in the flight data logs. The flight data logs may be stored on a removable medium. The medium can be installed on the ground control system or onboard the UAV. The data logs may be wirelessly transmitted to the ground control system or to the FPS.

Modules, programs or instructions for performing flight operations, contingency maneuvers, and other functions may be performed with operating system 320. In some implementations, the operating system 320 can be a real time operating system (RTOS), UNIX, LINUX, OS X, WINDOWS, ANDROID or other operating system 320. Additionally, other software modules and applications may run on the operating system 320, such as a flight control module 322, contingency module 324, inspection module 326, database module 328 and mission module 329. In particular, inspection module 326 can include computer instructions that, when executed by processor 335, can cause processor 335 to control the UAV to perform solar panel inspection operations as described below. Typically, flight critical functions will be performed using the UAV primary computer system 300. Operating system 320 may include instructions for handling basic system services and for performing hardware dependent tasks.

In addition to the UAV primary computer system 300, the secondary computer system 302 may be used to run another operating system 372 to perform other functions. The UAV secondary computer system 302 can be a system of one or more computers, or software executing on a system of one or more computers, which is in communication with, or maintains, one or more databases. The UAV secondary computer system 302 can include a processing subsystem 390 of one or more processors 394, GPU 392, and I/O subsystem 393. The UAV secondary computer system 302 can include logic circuits, analog circuits, associated volatile and/or non-volatile memory, associated input/output data ports, power ports, etc., and include one or more software processes executing on one or more processors or computers. The UAV secondary computer system 302 can include memory 370. Memory 370 may include non-volatile memory, such as one or more magnetic disk storage devices, solid-state hard drives, flash memory. Other volatile memory such a RAM, DRAM, SRAM may be used for storage of data while the UAV is operational.

Ideally, modules, applications and other functions running on the secondary computer system 302 will be non-critical functions in nature. If the function fails, the UAV will still be able to operate safely. The UAV secondary computer system 302 can include operating system 372. In some implementations, the operating system 372 can be based on real time operating system (RTOS), UNIX, LINUX, OS X, WINDOWS, ANDROID or other operating system.

Additionally, other software modules and applications may run on the operating system 372, such as an inspection module 374, database module 376, mission module 378 and contingency module 380. In particular, inspection module 374 can include computer instructions that, when executed by processor 394, can cause processor 394 to control the UAV to perform solar panel inspection operations as described below. Operating system 372 may include instructions for handling basic system services and for performing hardware dependent tasks.

The UAV can include controllers 346. Controllers 346 may be used to interact with and operate a payload device 348, and other devices such as cameras 349A and 349B. Cameras 349A and 349B can include a still-image camera, video camera, infrared camera, multispectral camera, stereo camera pair. In addition, controllers 346 may interact with a Lidar, radio transceiver, sonar, laser ranger, altimeter, TCAS, ADS-B (Automatic dependent surveillance-broadcast) transponder. Optionally, the secondary computer system 302 may have controllers to control payload devices.

The UAV 102 illustrated in FIGS. 1-3 is an example provided for illustrative purposes. The UAV 102 in accordance with the present disclosure may include more or fewer components than are shown. For example, while a quadcopter is illustrated, the UAV 102 is not limited to any particular UAV configuration and may include hexacopters, octocopters, fixed wing aircraft, or any other type of independently maneuverable aircraft, as will be apparent to those of skill in the art having the benefit of the disclosure herein. Furthermore, the navigation of an autonomous UAV 102 may be guided by other types of vehicles (e.g., spacecraft, land vehicles, watercraft, submarine vehicles, etc.).

The following paragraphs describe a drone communication system for maintaining a persistent wireless connection between a drone and controller using previously stored connection state of the wireless connection.

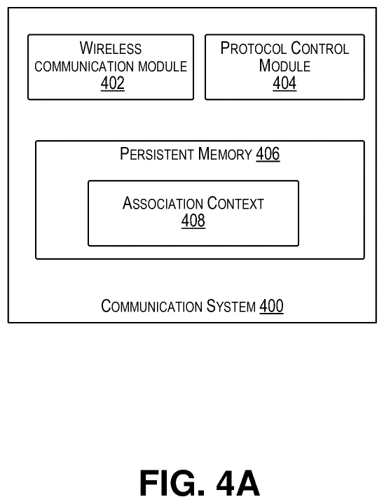

FIGS. 4A and 4B illustrate a communication system architecture for always connected mode in drones, consistent with various embodiments. Referring to FIG. 4A, a drone communication system 400 includes a set of components configured to manage wireless connectivity between a drone (e.g., UAV 102) and a controller 452. The controller 452 may be a computing device, such as a mobile phone, or a ground control station (GCS) used to issue mission instructions to the drone 102. The communication system 400 includes a wireless communication module 402, a protocol control module 404, and a persistent memory 406. Together, these components enable establishment of a wireless link 410 between the drone 102 and controller 452 using an 802.11-based protocol in both standard connection mode and always connected mode.

In accordance with conventional IEEE 802.11 terminology, the drone 102 is configured to operate as an access point (AP), and the controller 452 is configured to operate as a station (STA). This role assignment aligns with standard Wi-Fi networking models, where an AP advertises beacon frames and manages connection state, and the STA scans for available networks and initiates association. In this UAV system, the drone 102 functions analogously to a Wi-Fi router or hotspot, acting as the persistent network anchor. The controller 452 functions as a client device, initiating and resuming connections with the drone 102. This AP/STA configuration supports the persistent connectivity required by the always connected mode, allowing the drone 102 to retain the wireless link 410 and resume encrypted communication even when the controller 452 roams, reboots, or experiences temporary disconnection.

In a standard connection mode 412, the wireless link 410 is established by executing the full 802.11 standard connection process, which includes (a) beaconing, where the AP advertises beacons, (b) scanning, where the STA scans for known SSIDs with probe requests, and then selecting the AP to connect with, (c) authentication, where STA sends an authentication requests and the AP responds with an authentication response, (d) association with the AP, where the STA sends an association request after successful authentication and the AP responds with an association response, and (e) 4-way handshake, where the encryption keys (e.g., pairwise transient key (PTK) and group temporal key (GTK)) for securing the communication frames are derived (e.g., using WPA2 or other such similar protocol) and used in communication. Typically, the drone 102 and the controller 452 connect to each other for the first time using the standard connection mode 412.

In the always connected mode 414, the drone 102 and controller 452 re-establish a lost wireless link 410 (e.g., due to reboot of drone or controller, drifting out of the range of wireless link, connection drop, or other such reason), using a previously stored connection state of the wireless link, referred to as the “association context.” The association context 408 is generated during the standard connection mode (e.g., when the wireless link 410 is established for the first time) and includes, among other elements, an association response and an encryption key (e.g., PTK or GTK) derived during the standard connection. In some implementations, the always connected mode 414 does normal discovery of BSS and then avoids the rest based on the stored context. That is, the always connected mode 414 can bypass authentication, association, and key negotiation of the standard connection mode 412 by using the stored association context 408 to re-establish the wireless link 410. In some embodiments, the drone 102 and the controller 452 attempt to reconnect using the always connected mode 414 in response to a reconnection event, including upon reboot of the drone or controller, or disconnection of the wireless link 410 due to various reasons (e.g., proximity, out of signal range, below threshold signal strength, etc.).

Referring to the components of the communication system 400, the wireless communication module 402 is responsible for managing the physical and MAC layer interactions with the controller, including transmission and reception of 802.11 frames. It supports both standard EDCA-based connection behavior and modified initialization logic in always connected mode. The wireless communication module 402 may include a wireless transceiver such as the radio transceiver 359 of FIG. 3. The protocol control module 404 may be implemented as a separate module in the operating system 320, or may be integrated with one of the existing modules of the UAV 102.

The protocol control module 404 manages higher-layer wireless connection logic, including standard mode connection operations, and the always connected mode operations. The protocol control module 404 may also be responsible for interfacing with wireless driver-level components (QCA driver) to restore stored connection context during reconnection events.

The persistent memory 406 stores association context that enables the resumption of a previously established wireless link 410. Stored within the persistent memory is an association context 408, which includes data such as the association response frame and encryption keys (e.g., PTK and GTK) that were exchanged during the initial standard 802.11 connection process. This association context 408 allows the drone 102 to reengage in encrypted communication with a previously paired controller 452 without repeating the standard 802.11 connection sequence.

To enable the always connected mode 414, some components of the standard 802.11 protocol stack may be modified, specifically in the driver and the protocol layers. These modifications allow bypassing standard connection mode 412 operations and re-establishing wireless link 410 using always connected mode 414 operations, which includes storing and restoring of the association context. For example, wpa_supplicant and hostapd components in the protocol control module 404, along with the wireless driver, are modified to support always connected mode 414.

In some embodiments, the wpa_supplicant is modified to save the association context 408 on the controller 452. This association context 408, which includes association response received from the drone 102 and the encryption keys (e.g., PTK/GTK) derived during the standard connection mode 412, is saved to a specified location in the persistent memory 406 of the controller 452. The modified wpa_supplicant also triggers reconnection in the always connected mode 414 by loading the association context 408 from the persistent memory 406 to the wireless driver (e.g., using the driver application programming interface (API)), when the connection between the controller 452 and the drone 102 is lost.

In some embodiments, the hostapd is modified to save the association context 408 on the drone 102. The association context 408, which includes the association response, encryption keys (e.g., PTK/GTK), is saved to a specified location in the persistent memory 406 of the drone 102. In some embodiments, the association context 408 stored on the drone 102 may also include an association request frame received from the controller 452 during the standard connection mode 412, the association ID (AID) identifying the controller 452, key slots assignments used by the wireless driver, the MAC address of the controller 452, or other session-specific information. In some embodiments, the modified hostapd manages the association context on a per-controller basis, storing the association context for each controller that drone 102 connects with. During reconnection, the modified hostapd retrieves the appropriate association context 408 from the persistent memory 406 and provides it to the wireless driver using the driver API to re-establish the wireless link 410.

In some embodiments, the drone may store multiple association contexts in persistent memory, each mapped to a unique controller MAC address. The protocol control module may include a context management table indexed by controller identifiers, timestamps, or priority values. During reconnection, the drone may iterate through stored contexts and attempt restoration with the most recently used or most likely controller. This enables a UAV to pair with multiple ground stations or pilots across a mission lifecycle without requiring full reauthentication for each switch.

In some embodiments, the wireless driver, which handles MLME (MAC Layer Management Entity) functions like beaconing, scanning, authentication, association, and the 4-way handshake during the standard connection mode 412, is modified to bypass these functions. The modified driver accepts the stored association context 408 from the wpa_supplicant or the hostapd and initializes the MLME state to re-establish the wireless link 410. On the controller 452, the driver loads the PTK/GTK keys into key slots, marks the wireless connection as “complete” to re-stablish the wireless link 410, and resumes secure communication without requiring beaconing, probing, or authentication or association steps. On the drone 102, the wireless driver initializes the MLME state using the saved association context, which includes setting the flags to indicate the controller is “authenticated and associated,” loading the PTK/GTK keys into key slots, and assigning the keys to the correct controller 452 MAC address, re-establishing the wireless link 410 without the need for probe requests, authentication, or association stages. Once the wireless link 410 is re-established, encrypted communication between the drone 102 and the controller 452 resumes seamlessly.

In some embodiments, the wireless driver temporarily disables packet number (PN) replay checks on the drone 102 during the reconnection process to avoid mismatches in the transmit sequence numbers (e.g., caused by sequence number resets on the controller 452). The driver may reenable the PN replay checks after the connection is successfully established.

During reconnection using the always connected mode, the protocol control module may disable Packet Number (PN) replay protection checks temporarily at the drone. This is achieved by modifying PN validation logic within the firmware or driver to permit out-of-sequence or reset PN values during a configurable grace period. Once encrypted packets with expected sequence continuity are received from the controller, PN checks are automatically reenabled. Optionally, the duration or condition for this bypass may be configurable via a parameter file to balance robustness and security.

In some embodiments, the protocol control module 404 includes a configuration file containing an always connected mode status flag, which determines whether the always connected mode 414 is enabled or disabled. For example, when the flag is set to a first value, such as “1,” the always connected mode is enabled, allowing reconnection using the stored association context 408. When the flag is set to a second value, such as “0,” the always connected mode is disabled, and the devices connect using the standard connection mode 412.

In some embodiments, the communication system 400 supports a rekeying feature that refreshes the PTK after reconnection via the always connected mode 414. This is particularly useful when the drone 102 remains in a non-flight or idle state following reconnection, and the controller 452 initiates uplink traffic. The PTK is regenerated to maintain session security, while the GTK typically remains unchanged to ensure compatibility across previously connected controllers. This selective rekeying mechanism enhances the cryptographic integrity of persistent sessions without requiring full reassociation.

Following reconnection using the stored association context, the drone may perform a selective rekeying of the Pairwise Transient Key (PTK) upon detecting uplink traffic from the controller. This PTK refresh operation is triggered by a flag or handshake initiated by the controller and allows for cryptographic renewal without full reassociation. The Group Temporal Key (GTK), which is common across devices, may remain unchanged to preserve compatibility across multiple controllers. This selective rekeying ensures secure continuity without degrading reconnection latency.

The communication system 400 also manages the AMPDU negotiations within always connected mode 414. In some embodiments, the wireless driver detects any AMPDU or BA mismatches and re-establishes a new BA session implicitly (e.g., creating a new BA), or re-initiates Add Block ACK (ADDBA) negotiation, eliminating the need to store and restore BA sessions. This allows the communication system to avoid full disassociation between the drone and the controller, and resume high-throughput AMPDU communication after reconnection.

As illustrated in FIG. 4B, the drone 102 includes a communication system 400a and the controller 452 includes a communication system 400b, each similar to communication system 400. Both systems are configured to operate in either standard connection mode 412 or always connected mode 414.

In the standard connection mode 412, the communication systems follow the typical 802.11 connection establishment process, including beacon scanning, authentication, association, and a four-way handshake to derive fresh encryption keys. In contrast, always connected mode 414 bypass these procedures by restoring the previously stored association context 408, as described above. Typically, initial pairing between the drone 102 and the controller 452 occurs through the standard connection mode 412, during which the association context 408 is generated and stored in the persistent memory 406 of the respective devices. This association context 408 can later be used in re-establishing the wireless link 410 without repeating the entire 802.11 connection process of the standard connection mode 412.

The always connected mode 414 is particularly useful in conditions where the drone 102 and controller 452 become disconnected due to wireless range limitations, interference, or a reboot event. In such scenarios, a standard reconnection may fail due to the inability to complete beacon discovery or key negotiation. Instead, the communication systems 400a and 400b use the stored association context 408 to directly reinitialize the MAC layer state within the wireless driver, enabling secure communication over the wireless link 410 without performing full reassociation.

The overall architecture ensures continuity of the wireless link 410 even across reboots or extended range separations, making it especially well-suited for autonomous UAV operations in mission-critical or long-range environments.

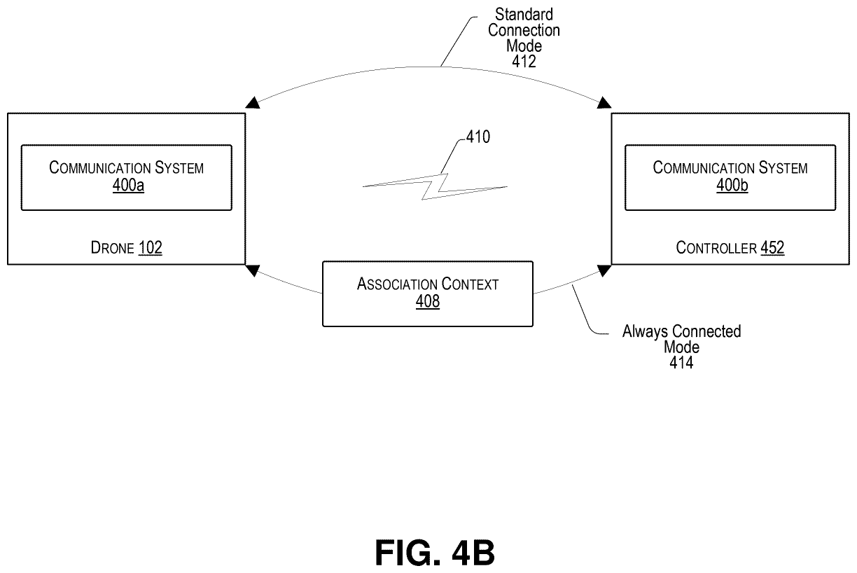

FIG. 5 is a flow diagram of a method for establishing a wireless connection between a drone and a controller using a standard connection mode, consistent with various embodiments. In some embodiments, the method 500 may be implemented in the environment of FIG. 4B.

At block 502, the communication systems 400a and 400b of the drone 102 and the controller 452, respectively, establish a wireless link 410 using standard connection mode 412. In the standard connection mode 412, the protocol control module 404 establishes the wireless link 410 by executing the full 802.11 standard connection process, which includes (a) beaconing, where the drone 102 advertises beacons, (b) scanning, where the controller 452 scans for known SSIDs with probe requests, and selects the drone to connect with, (c) authentication, where the controller 452 sends an authentication request and receives an authentication response from the drone 102, (d) association, where the controller 452 sends an association request after successful authentication and receives an association response from the drone 102, and (c) 4-way handshake, where the encryption keys (e.g., PTK and GTK) are derived (e.g., using WPA2 or other such similar protocol) for securing subsequent communication. This connection process typically occurs during the initial pairing between the drone 102 and the controller 452. Once the wireless link 410 is established, secure communication begins.

At block 504, the communication systems generate an association context 408, which includes connection state data related to the wireless link 410. The association context 408 includes, among other elements, an association response and encryption keys (e.g., PTK/GTK) derived during the initial standard 802.11 connection process (e.g., at block 502 above). In some embodiments, at the drone 102, the association context 408 may also include additional information such as an association request frame received from the controller 452; the AID identifying the controller 452; key slot assignments managed by the wireless driver; the MAC address of the controller 452, or other session-specific information.

At block 506, the communication systems store the association context in a persistent memory of the device. For example, the protocol control module 404 on the controller 452 may store the association context 408 at a specified location in the persistent memory 406 of the controller 452, and the protocol control module 404 at the drone 102 may store the association context 408 at a specified location in the persistent memory 406 of the drone 102. The storage location may be specified in a configuration file.

In some embodiments, components of the 802.11 protocol stack are modified to support generation and persistent storage of the association context. For example, the wpa_supplicant component on the controller 452 and the hostapd component on the drone 102 are modified to generate and store the association context in the persistent memory 406.

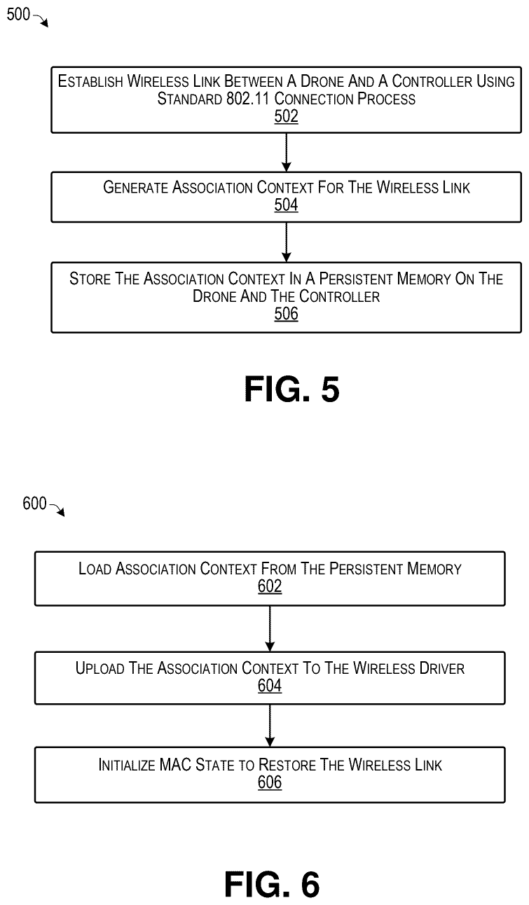

FIG. 6 is a flow diagram of a method for reestablishing a wireless connection between a drone and a controller using an always connected mode, consistent with various embodiments. In some embodiments, the method 600 may be implemented in the environment of FIG. 4B. The method 600 may apply in scenarios where the drone 102 and controller 452 become disconnected due to wireless range limitations, interference, a reboot event or other similar conditions. In such cases, the communication systems may attempt reconnection via the always connected mode 414 using the association context 408 (e.g., as generated in the process shown in FIG. 5).

At block 602, the communication systems load the association context from the persistent memory 406. For example, the protocol control module 404 retrieves the stored association context 408 from the designated location in the persistent memory 406.

At block 604, the protocol control module 404 uploads the association context 408 to the wireless driver (e.g., QCA driver), using the driver API.

At block 606, the wireless driver initializes the MLME state using the retrieved association context 408. On the controller 452, this initialization includes loading the PTK/GTK keys into key slots and marking the wireless connection as “complete,” re-stablishing the wireless link 410, without executing beaconing, scanning, authentication, and association. The MAC layer remains fully functional and secure, allowing immediate data transfer.

On the drone 102, initializing the MLME state includes setting flags indicating the controller 452 is “authenticated and associated” and loading the PTK/GTK keys into key slots and mapping the keys to the correct controller 452 MAC address, re-stablishing the wireless link 410 while bypassing the probe request, authentication and association stages.

Once the wireless link 410 is re-established, secure communication between the drone 102 and the controller 452 may resume. In some embodiments, the wireless driver also disables PN replay checks on the drone 102 temporarily during the reconnection process to avoid any transmit sequence number mismatches, and reenables the PN replay checks after the wireless link 410 is reestablished.

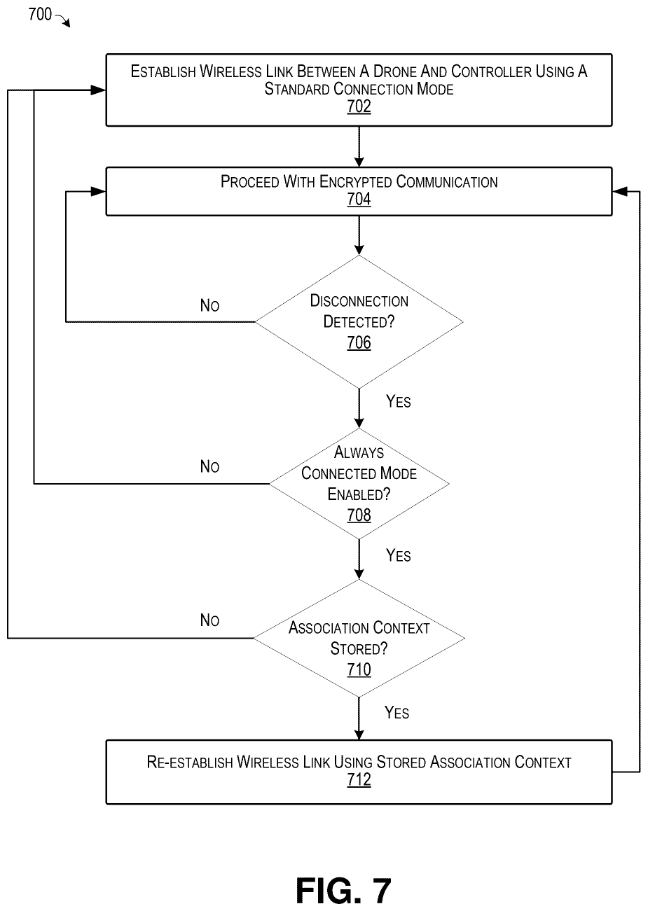

FIG. 7 is a flow diagram of a method 700 for maintaining a wireless connection between a drone and a controller using a standard connection mode or always connected mode, consistent with various embodiments.

At block 702, the communication systems establish a wireless link 410 between the drone 102 and controller 452 using a standard connection mode 412. This includes the standard IEEE 802.11 association process such as beaconing, scanning, authentication, association, and a 4-way handshake to derive encryption keys (e.g., PTK and GTK). The communication systems also store association context 408, which includes connection state information, as described at least with reference to FIGS. 4A and 5 above.

Once the wireless link 410 is established, at block 704, encrypted communication is conducted over the established wireless link 410. The communication systems may continuously monitor for disruptions to the wireless link 410.

At decision block 706, a determination is made as to whether a disconnection has been detected. In some embodiments, the determination is made by at least one of the drone 102 or the controller 452. If no disconnection is detected, the communication system continues with encrypted communication at block 704. If a disconnection is detected, the method proceeds to decision block 708.

At block 708, the communication system determines whether the always connected mode 414 is enabled. This is a configurable feature that enables the use of stored association context to bypass the standard connection sequence during reconnection. In some embodiments, the always connected mode 414 can be enabled or disabled using a status flag that is set in a configuration file associated with wpa_supplicant or the hostapd component of the 802.11 protocol stack. If always connected mode 414 is not enabled, the communication system reverts to initiating the connection in standard connection mode 412 (looping back to block 702).

If always connected mode is enabled, at block 710, the communication systems evaluate whether an association context 408 is available in the persistent memory 406. This association context typically includes a previously received association response and associated encryption keys (e.g., as described at least with reference to FIG. 5). If the association context 408 is not stored or is invalid, the communication system again returns to block 702 to initiate a new connection using standard connection mode 412. If a valid association context is available, at block 712, the wireless link 410 is re-established using the stored association context 408. This bypasses the need for authentication, association, and key negotiation of the standard 802.11 connection process, allowing encrypted communication to resume almost immediately. This always connected mode 414 enables robust and seamless reconnection between the drone 102 and the controller 452, especially in scenarios where standard 802.11 procedures are ineffective due to range, interference, or device reboot.

The following paragraphs describe various conditions in which the communication system switch between standard connection mode 412 and always connected mode 414.

In some embodiments, the communication system 400 supports dynamic switching between these two modes based on real-time operational conditions. A decision engine within the communication system 400 evaluates multiple factors to determine whether always connected mode 414 is viable or whether a standard connection mode 412 is required. This switching logic ensures that the optimal reconnection method is used to maintain robust communication without compromising security or compatibility.

In some embodiments, the drone may be configured to operate initially in standard connection mode upon power-up or reboot and subsequently switch to always connected mode based on contextual evaluation of operational parameters. For example, if no beacon requests are received within a threshold time window, the protocol control module may consult a mode selection policy stored in memory and attempt to restore the prior session using the stored association context. This initial fallback to always connected mode may be prioritized when the drone is operating beyond expected beacon range or during mid-mission reboot scenarios.

For example, if a disconnection is detected and the controller 452 reboots while out of beacon range of the drone 102, and the always connected mode 414 is enabled and valid association context 408 is stored, the communication system 400 automatically attempts reconnection using the always connected mode 414. Conversely, if the controller 452 is within close proximity to the drone 102 and beacons are readily received, or if the stored association context 408 is unavailable or invalid, the communication system 400 falls back to the standard connection mode 412.

Other switching triggers may include link quality metrics, such as Received Signal Strength Indicator (RSSI) or Signal-to-Noise Ratio (SNR) thresholds, indicating whether standard connection mode 412 is likely to succeed; channel mismatch or drift, where the STA performs a background scan if the AP's beacon is not detected; session age or expiration policies, where stored context may be deemed stale; security configuration, such as policy-enforced reauthentication after specific time intervals or events; and UAV state, such as whether the drone is grounded, in flight, or transitioning between operational modes.

For example, if the RSSI or SNR is below a threshold level, the communication system 400 may switch from standard connection mode 412 to always connected mode 414. In another example, if the controller fails to detect beacon frames from the drone 102 or detects them on an unexpected channel, the communication system 400 may switch from standard connection mode 412 to always connected mode 414. In another example, when the association context is missing, expired, or deemed invalid due to format, policy, or version mismatch, the communication system 400 may switch from always connected mode 414 to standard connection mode 412. In another example, if the drone 102 is grounded or idle for a specified period when reconnection occurs, the connection will be via always connected mode 414, but rekeying of the PTK is triggered after initial communication resumes. In yet another example, when a security policy requires periodic reauthentication, or the time since the last full association exceeds a defined threshold, the communication system 400 may switch from always connected mode 414 to standard connection mode 412.

By continuously evaluating these conditions, the communication system 400 ensures resilient and context-aware reconnection behavior that maximizes uptime and minimizes latency during UAV operations.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Although described primarily in the context of a drone-to-controller link, the always connected mode may also be applied to drone-to-drone communication scenarios, such as in autonomous swarm formations. In such cases, one UAV may function as a temporary access point, and another as a station, with association context exchanged and stored during formation. Upon disconnection due to mobility or interference, the reconnecting UAV may restore the link with the peer using the stored context without a new 4-way handshake, maintaining formation cohesion and data exchange continuity.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (e.g., an angle that lies within the range of (approximately) 135° to (approximately) 225°). The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

As used herein, unless specifically stated otherwise, the term “or” encompasses all possible combinations, except where infeasible. For example, if it is stated that a component includes A or B, then, unless specifically stated otherwise or infeasible, the component may include only A, or only B, or A and B. As a second example, if it is stated that a component includes A, B, or C, then, unless specifically stated otherwise or infeasible, the component may include only A, or only B, or only C, or A and B, or A and C, or B and C, or A and B and C. Expressions such as “at least one of” do not necessarily modify an entirety of a following list and do not necessarily modify each member of the list, such that “at least one of A, B, and C” should be understood as including only A, or only B, or only C, or any combination of A, B, and C. The phrase “one of A and B” or “any one of A and B” shall be interpreted in the broadest sense to include one of A, or one of B.

The descriptions herein are intended to be illustrative, not limiting. Thus, it will be apparent to one skilled in the art that modifications may be made as described without departing from the scope of the claims set out below.

The present techniques will be better understood with reference to the following enumerated embodiments:
1. A drone communication system comprising:
   (a) a drone configured to operate as a wireless access point (AP);
   (b) a controller configured to operate as a wireless station (STA);
   (c) a wireless communication module on each of the drone and controller configured to perform an initial 802.11 association including a key exchange;
   (d) a persistent memory in at least one of the drone and controller configured to store an association response frame and one or more encryption keys derived during the initial association; and
   (e) a protocol control module configured to, upon a disconnection or reboot, reestablish a wireless link between the drone and controller using the stored association response and encryption keys without performing a full 802.11 re-association and key exchange.
2. The system of any of the preceding embodiments, wherein the protocol control module comprises a modified wpa_supplicant on the controller that retrieves the stored association response and encryption keys from persistent memory and injects the same into a wireless driver.
3. The system of any of the preceding embodiments, wherein the protocol control module comprises a modified hostapd on the drone configured to store per-station context in a persistent directory and restore the same upon reboot.
4. The system of any of the preceding embodiments, wherein the system bypasses authentication, association, and 4-way handshake during reconnection.
5. The system of any of the preceding embodiments, wherein the wireless driver accepts association context and key material via vendor-specific Netlink commands.
6. The system of any of the preceding embodiments, further comprising a replay protection module configured to disable packet number (PN) checking upon reconnection and re-enable the same after a successful link is reestablished.
7. The system of any of the preceding embodiments, wherein the drone and controller selectively switch between the always connected mode and standard association mode based on one or more of: beacon reception, link quality, or connection state.
8. The system of any of the preceding embodiments, wherein the wireless driver includes a custom mode that initializes MLME state using a previously saved association frame and keys.
9. The system of any of the preceding embodiments, further comprising a mechanism to rekey a pairwise key (PTK) after the controller transmits an initial uplink packet following reconnection.
10. The system of any of the preceding embodiments, wherein AMPDU sessions and Block ACK agreements are re-established implicitly by the firmware upon receiving aggregated frames after reconnection.
11. The system of any of the preceding embodiments, wherein the protocol control module is further configured to selectively switch between a standard 802.11 connection mode and an always connected mode based on one or more runtime conditions.
12. The system of any of the preceding embodiments, wherein the runtime conditions include at least one of: received signal strength (RSSI), absence of beacon frames, availability of stored association context, link status, or operational state of the UAV.
13. The system of any of the preceding embodiments, wherein the protocol control module switches from the standard connection mode to the always connected mode when beacon frames are not detected by the controller and a valid association context is available in persistent memory.
14. The system of any of the preceding embodiments, wherein the protocol control module switches from the always connected mode to the standard connection mode when the association context is missing, invalid, or expired.
15. The system of any of the preceding embodiments, wherein the protocol control module triggers the always connected mode in response to a detected disconnection event and determines whether the stored association context can be reused for reinitializing the MAC state.
16. A method for maintaining persistent wireless connectivity between a drone and a controller, comprising:
   performing a standard 802.11 association between the drone and controller using WPA2-PSK;
   storing an association response frame and one or more derived encryption keys to persistent memory on at least one of the drone and controller;
   upon detecting a reconnection scenario, retrieving the stored association response frame and encryption keys;
   injecting the retrieved context into a wireless driver stack; and
   resuming encrypted communication without repeating the authentication, association, and 4-way handshake.
17. The method of any of the preceding embodiments, further comprising disabling PN replay protection on the drone during reconnection.
18. The method of any of the preceding embodiments, wherein the controller sends the association response and keys to the driver using vendor-specific Netlink commands.
19. The method of any of the preceding embodiments, further comprising initiating a background scan on the controller when beacons from the drone are not detected.
20. The method of any of the preceding embodiments, further comprising refreshing the PTK key if the drone remains idle following reconnection.
21. The method of any of the preceding embodiments, further comprising detecting AMPDU transmission with an outdated Block ACK session and allowing firmware to renegotiate or implicitly create a new Block ACK session.
22. The method of any of the preceding embodiments, further comprising monitoring link quality and switching from standard mode to always connected mode when signal strength falls below a threshold.
23. The method of any of the preceding embodiments, further comprising detecting a mismatch between expected and received channel information and invoking always connected mode to restore the link using stored session data.
24. The method of any of the preceding embodiments, further comprising switching from always connected mode to standard mode when a security policy requires reauthentication based on a timeout or session expiration interval.
25. An autonomous unmanned aerial vehicle (UAV) comprising:
   a wireless communication system configured to operate as an 802.11 access point or station;
   a memory configured to store a previously established wireless session context comprising an association response frame and one or more cryptographic keys; and
   a control processor programmed to:
      (i) detect a reconnection scenario during autonomous flight operations;
      (ii) retrieve the stored wireless session context;
      (iii) transmit the session context to a wireless driver; and
      (iv) resume secure wireless communication with a paired controller or peer UAV without initiating a full 802.11 association procedure.
26. The autonomous UAV of any of the preceding embodiments, wherein the control processor is further programmed to disable packet number (PN) replay protection during the reconnection process and to re-enable the protection upon successful reestablishment of communication.
27. The autonomous UAV of any of the preceding embodiments, wherein the wireless driver is configured to initialize MAC layer management state based on the retrieved association response frame and to program the cryptographic keys into corresponding key slots.
28. The autonomous UAV of any of the preceding embodiments, wherein the control processor is further programmed to switch between always connected mode and standard association mode based on one or more criteria including: received signal strength, beacon availability, or proximity of the peer device.
29. The autonomous UAV of any of the preceding embodiments, wherein the control processor is further programmed to evaluate operational state data, and in response to the UAV being in a rest or idle state after reconnection, initiate a rekeying process while remaining in the always connected mode.
30. The autonomous UAV of any of the preceding embodiments, wherein the control processor is further programmed to initiate full reassociation when the UAV enters a flight-critical state and session context cannot be validated, thereby switching from always connected mode to standard connection mode.
31. A non-transitory computer-readable medium storing instructions that, when executed by one or more processors of a drone communication system, cause the system to:
   (a) detect a reconnection condition;
   (b) retrieve previously saved wireless session data including an association response frame and encryption keys;
   (c) send the session data to a wireless driver; and
   (d) resume secure communication with a peer device without performing a full 802.11 association procedure.
32. The computer-readable medium of any of the preceding embodiments, wherein the instructions further cause the system to disable packet number checking temporarily during reconnection.
33. The computer-readable medium of any of the preceding embodiments, wherein the wireless driver initializes MLME state using the saved association response frame.
34. The computer-readable medium of any of the preceding embodiments, wherein the instructions cause the device to switch to standard association mode when link quality exceeds a predefined threshold or when beacon frames are received.
35. A tangible, non-transitory, machine-readable medium storing instructions that, when executed by a data processing apparatus, cause the data processing apparatus to perform operations comprising those of any of embodiments 1-34.
36. A system comprising: one or more processors; and memory storing instructions that, when executed by the processors, cause the processors to effectuate operations comprising those of any of embodiments 1-34.
37. A system comprising means for performing any of embodiments 1-34.

What is claimed is:

1. A communication system for a drone, comprising:
a wireless communication module configured to establish a wireless link between a drone and a controller by executing a standard 802.11 connection process including association, authentication and key exchange;
a persistent memory in at least one of the drone and controller configured to store an association context including an association response and an encryption key derived during the standard 802.11 connection process; and
a protocol control module configured to, in response to a reconnection event, reestablish the wireless link using the association context without executing the standard 802.11 connection process.

2. The communication system of claim 1, wherein the protocol control module includes:
a first modified component of an 802.11 protocol on the controller configured to retrieve the stored association context from the persistent memory and load the association context into a wireless driver.

3. The communication system of claim 2, wherein the first modified component is wpa_supplicant of the 802.11 protocol.

4. The communication system of claim 1, wherein the protocol control module includes:
a second modified component of an 802.11 protocol on the drone configured to store the association context in the persistent memory and load the association context into a wireless driver during reconnection.

5. The communication system of claim 4, wherein the second modified component is hostapd of the 802.11 protocol.

6. The communication system of claim 1 further comprising:
a wireless driver configured to accept the association context from the protocol communication module and upload the association context to the wireless communication module to reestablish the wireless link.

7. The communication system of claim 1, wherein the protocol control module is further configured to disable packet number (PN) checking at the drone during reconnection and re-enable the PN checking after the wireless link is reestablished.

8. The communication system of claim 1, wherein the protocol control module is configured to bypass at least a portion of the standard 802.11 connection process and use the association context to re-establish the wireless link based on an always connected flag set in a configuration file.

9. The communication system of claim 1, wherein the protocol control module is configured to selectively switch between an always connected mode and a standard connection mode to establish the wireless link based on a proximity of the drone to the controller or a quality of the wireless link.

10. The communication system of claim 1, wherein the protocol control module is configured to rekey a pairwise key (PTK) after the controller transmits an initial uplink packet to the drone following reconnection.

11. The communication system of claim 1, wherein the protocol control module is configured to re-establish Aggregated MAC Protocol Data Unit (AMPDU) sessions and block acknowledgement (Block ACK) agreements upon receiving aggregated frames after reconnection.

12. A method for maintaining persistent wireless connectivity between a drone and a controller, the method comprising:
establishing a wireless link between a drone and a controller by executing a standard connection process of an 802.11 protocol;
storing an association context including an association response and encryption keys derived during the standard connection process; and
reestablishing the wireless link during reconnection using the association context without executing the standard connection process.

13. The method of claim 12, wherein storing the association context includes:
storing the association context at the controller using a modified wpa_supplicant component of the 802.11 protocol, and
storing the association context at the drone using a modified hostapd component of the 802.11 protocol.

14. The method of claim 12, wherein reestablishing the wireless link includes:
causing a wireless driver component to:
accept the association context from modified components of the 802.11 protocol, and
bypass at least a portion of the standard connection process by using the association context to reestablish the wireless link.

15. The method of claim 12 further comprising:
disabling packet number (PN) checking at the drone upon reconnection, and
re-enabling the PN checking after the wireless link is reestablished.

16. The method of claim 12 further comprising:
storing the association context at the drone along with a key slot, wherein the key slot is an identifier indicative of the controller with which the association context is associated.

17. The method of claim 12 further comprising:
refreshing a PTK key of the encryption keys if the drone remains idle for a specified period following reconnection.

18. An autonomous unmanned aerial vehicle (UAV) comprising:
one or more sensors configured to capture perception inputs of a physical environment;
a propulsion system configured to maneuver the UAV through the physical environment; and
a communication system including a protocol control module configured to:
detect a disconnection of a wireless link with a controller,
retrieve, from a persistent memory of the UAV, an association context having an association response and encryption keys, wherein the association context was derived during a standard connection process of an 802.11 protocol used to initially establish the wireless link with the controller, and
reestablish the wireless link using the association context without executing the standard connection process.

19. The autonomous UAV of claim 18, wherein the protocol control module includes:
a modified hostapd component of the 802.11 protocol configured to store the association context in the persistent memory and load the association context into a wireless driver during reconnection.

20. The autonomous UAV of claim 18, wherein the protocol control module is configured to bypass at least part of the standard connection process and use the association context to re-establish the wireless link based on an always connected flag set in a configuration file.
